(19) United States
(12) Patent Application Publication
(10) Pub. No.: US 2005/0243931 A1
(43) Pub. Date: Nov. 3, 2005

(54) Video encoding/decoding method and apparatus

(76) Inventors: Goki Yasuda, Fuchu-shi (JP); Takeshi Chujoh, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/114,125

(22) Filed: Apr. 26, 2005

(30) Foreign Application Priority Data
Apr. 28, 2004 (JP) 2004-134253

(51) Int. Cl. H04N 7/12

(52) U.S. Cl. 375/240.16; 375/240.12; 375/240.18; 375/240.03

(57) ABSTRACT

A method of encoding a video using motion compensated prediction includes determining an interpolation coefficient for making a prediction error between a to-be-encoded picture and a predictive picture minimize, the interpolation coefficient representing a pixel value change between the to-be-encoded picture and the encoded picture, interpolating a pixel in a position between adjacent pixels of the encoded picture using the interpolation coefficient to generate an interpolation picture, generating the predictive picture by subjecting the interpolation picture to motion compensated prediction, and encoding the prediction error between the to-be-encoded picture and the predictive picture.

### CROSS-REFERENCE TO RELATED APPLICATIONS

This application is based upon and claims the benefit of priority from prior Japanese Patent Application No. 2004-134253, filed Apr. 28, 2004, the entire contents of which are incorporated herein by reference.

### BACKGROUND OF THE INVENTION

1. Field of the Invention

The present invention relates to a video encoding/decoding method including doing a motion compensated prediction using an interpolated picture obtained by pixel-interpolating encoded picture and a video encoding/decoding apparatus therefor.

2. Description of the Related Art

There is a motion compensated prediction as one of techniques used for a video encoding. In the motion compensated prediction, a motion vector is derived using the to-be-encoded picture which is to be newly encoded by a video encoding apparatus and the encoded picture which is already encoded and provided by local decoding. A predictive picture is produced by motion compensation using the motion vector. The prediction error between the to-be-encoded picture and the predictive picture is subjected to orthogonal transformation, and an orthogonal transformation coefficient is quantized. The quantized orthogonal transformation coefficient and the motion vector information used for motion compensation are encoded and sent to a decoder apparatus. The decoder apparatus decodes the input encoded data and generates the predictive picture using the decoded picture, the prediction error and the motion vector information.

A motion compensated prediction method comprising generating an interpolation picture by interpolating a fractional pixel for an encoded picture using a filter, and predicting a picture using the interpolation picture and a motion vector is known. The fractional pixel is a pixel at the position between adjacent pixels of the encoded picture. The pixel at an intermediate position between, for example, adjacent pixels is called ½ pixel. In contrast, the pixels inherently contained in the encoded picture are referred to as integer pixels. A method of changing adaptively filters according to a to-be-encoded picture when the fractional pixel is interpolated is known. A method of determining a filter used for interpolation of the fractional pixel so that the square error between the pixel of the to-be-encoded picture and the pixel of the predictive picture become smallest is known (referred to T. Wedi, “Adaptive Interpolation Filter for Motion Compensated Prediction,” Proc. IEEE International Conference on Image Processing, Rochester, N.Y. USA, September 2002, for example).

On the other hand, Japanese Patent Laid-Open No. 10-248072 discloses a technique of predicting the brightness and color difference Cb, Cr of the to-be-encoded picture signal as Y=αY′+β, Cb=α Cb′, Cr=αCr′ using brightness Y′ and color differences Cb′, Cr″ of the encoded picture signal.

According to T. Wedi, a prediction error, namely an error between the to-be-encoded picture and the predictive picture becomes smaller than that of the prediction method using a single filter. However, T. Wedi does not consider such change of the pixel value between the to-be-encoded picture and the encoded picture as to be included in a fade-in/fade-out picture in interpolating the fractional pixel using a filter. Accordingly, such a pixel value change increases a prediction error.

On the other hand, Japanese Patent Laid-Open No. 10-248072 considers change of the pixel value between the to-be-encoded picture and the encoded picture. However, this prior technique relates to a prediction of a time course, and does not relate to an interpolation for motion compensated prediction.

It is an object of the present invention to provide a video encoding/decoding method of interpolating a fractional pixel in consideration of a pixel value change between a to-be-encoded picture and an encoded picture to decrease an error of predictive picture and an apparatus therefor.

### BRIEF SUMMARY OF THE INVENTION

An aspect of the present invention provides a method of encoding a video using motion compensated prediction comprising: determining an interpolation coefficient for making a prediction error between a to-be-encoded picture and a predictive picture minimize, the interpolation coefficient representing a pixel value change between the to-be-encoded picture and the encoded picture; interpolating a pixel in a position between adjacent pixels of the encoded picture using the interpolation coefficient to generate an interpolation picture; generating the predictive picture by subjecting the interpolation picture to motion compensated prediction; and encoding the prediction error between the to-be-encoded picture and the predictive picture.

Another aspect of the present invention provides a video decoding method comprising: decoding an input encoded data to derive a quantized orthogonal transformation coefficient, a motion vector and an interpolation coefficient representing a pixel value change between a to-be-decoded picture and a decoded pictures; interpolating a pixel in a position between adjacent pixels of the decoded picture using the interpolation coefficient to produce an interpolation picture; generating a predictive picture by subjecting the interpolation picture to motion compensated prediction using the motion vector to produce a predictive picture; obtaining a prediction error using the orthogonal transformation coefficient; and reproducing the to-be-decoded picture from the predictive picture and the prediction error.

### BRIEF DESCRIPTION OF THE SEVERAL VIEWS OF THE DRAWING

FIG. 1 is a block diagram of a video encoding apparatus concerning the first embodiment of the present invention;

FIG. 2 is a block diagram of a motion compensation prediction unit of FIG. 1;

FIG. 3 is a block diagram of a pixel interpolator of FIG. 2;

FIG. 4 shows a flowchart of a processing routine of the motion compensation prediction unit according to FIG. 1;

FIG. 5 is a diagram of describing motion compensated prediction;

FIG. 6 is a diagram of describing a horizontal interpolation;

FIG. 7 is a diagram of describing a horizontal interpolation in interpolating horizontally the pixel at a fractional pixel position;

FIG. 8 is a diagram of describing a vertical interpolation of interpolating vertically the pixel at the decimal pixel position in horizontal and vertical directions;

FIG. 9 is a block diagram of a video decode apparatus concerning the first embodiment of the present invention; and

FIG. 10 is a diagram of describing a vertical interpolation in the second embodiment of the present invention.

### DETAILED DESCRIPTION OF THE INVENTION

There will now be explained an embodiment of the present invention referring to drawing.

### First Embodiment

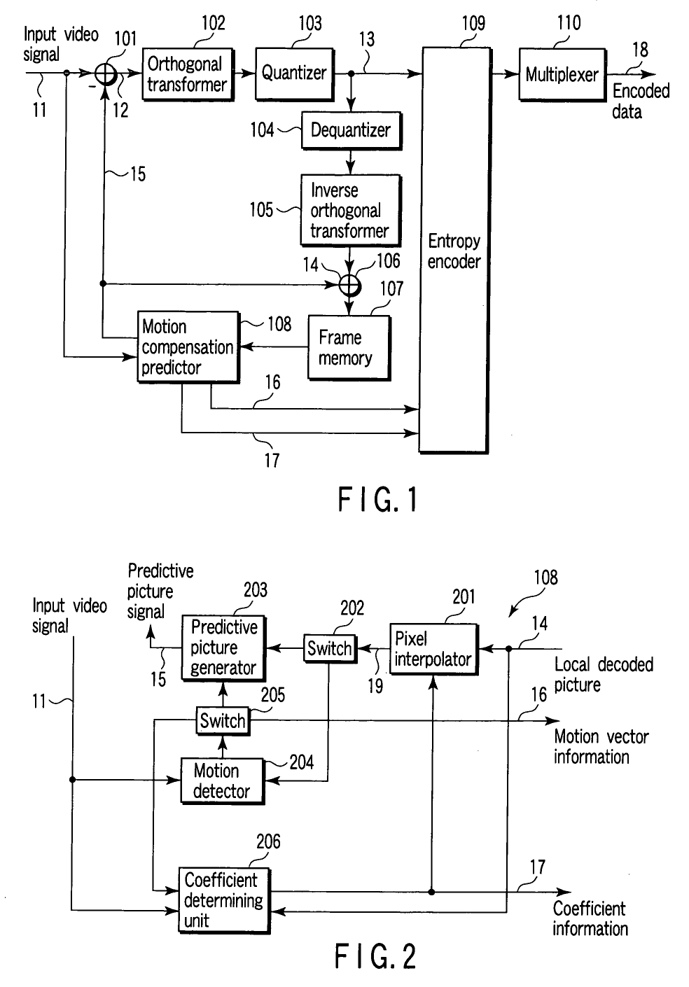

A video encoding apparatus concerning the first embodiment of the present invention is described with reference to FIG. 1.

The input video signal 11 of a to-be-encoded picture is input to a subtracter 101. A prediction error signal 12 is generated by deriving a difference between the input video signal 11 and a predictive picture signal 15. The prediction error signal 12 is subjected to orthogonal transformation by an orthogonal transformer 102 to generate orthogonal transformation coefficient. The orthogonal transformation coefficient is quantized with a quantizer 103.

The quantized orthogonal transformation coefficient information is dequantized by a dequantizer 104 and then is subjected to inverse orthogonal transformation with an inverse orthogonal transformer 105. An adder 106 adds the prediction error signal and the predictive picture signal 15 to generate a local decoded picture signal 14. The local decoded picture signal 14 is stored in a frame memory 107, and the local decoded picture signal read from the frame memory 107 is input to a motion compensation prediction unit 108.

The motion compensation prediction unit 108 receives the local decoded picture signal stored in the frame memory 107 and the input video signal 11 and subjects the local decoded picture signal to motion compensated prediction to generate a predictive picture signal 15. The predictive picture signal 15 is sent to a subtracter 101 to derive a difference with respect to the input video signal 11 and sent to an adder 106 to generate a local decoded picture signal 14.

The orthogonal transformation coefficient information 13 quantized with the quantizer 103 is input to an entropy encoder 109 such as arithmetic coding unit and subjected to entropy coding. The motion compensation prediction unit 108 outputs motion vector information 16 used for motion compensated prediction and interpolation coefficient information 17 indicating a coefficient used for interpolation for a fractional pixel, and subjects them to entropy coding with an entropy encoder 109. The quantized orthogonal transformation coefficient information 13, the motion vector information 16 and the interpolation coefficient information 17 output from the entropy encoder 109 are multiplexed with a multiplexer 110. The encoded data 18 is sent to a storage system or a transmission channel (not shown).

The motion compensation prediction unit 108 will be described referring to FIG. 2.

A pixel interpolator 201 generates an interpolation picture signal 19 based on the local decoded picture signal 14 from the adder 106 of FIG. 1 and the coefficient information 17 from the coefficient determination unit 206 as described in detail hereinafter. The interpolation picture signal 19 is input to a switch 202. The switch 202 selects sending the interpolation picture signal 19 to both of the predictive picture generator 203 and a motion detector 204 or sending it only to the motion detector 204. The motion detector 204 detects a motion vector from the interpolation picture signal 19 and the input video signal 11. The predictive picture generator 203 generates the predictive picture signal 15 from the interpolation picture signal 19 and the motion vector.

The motion vector detected by the motion detector 204 is input to the switch 205. The switch 205 selects sending motion vector information to both of the predictive picture generator 203 and the entropy encoder 109 or sending it only to a coefficient determination unit 206. The coefficient determination unit 206 determines the above-mentioned interpolation coefficient from the motion vector, the input video signal 11 and the local decoded picture signal 16. Concretely, the interpolation coefficient is determined to such a value as to minimize a square error between the input video signal 11 of the to-be-encoded picture and the predictive picture signal. Further, the interpolation coefficient is determined to such a value as to reflect a pixel value change between the input video signal 11 corresponding to the to-be-encoded picture and the local decoded picture signal read from the frame memory 107 which is an encoded picture.

The coefficient information 17 indicating the determined interpolation coefficient is send to the pixel interpolator 201 and the entropy encoder 109 shown in FIG. 1. The operation of the coefficient determination unit 306 will be described in detail later.

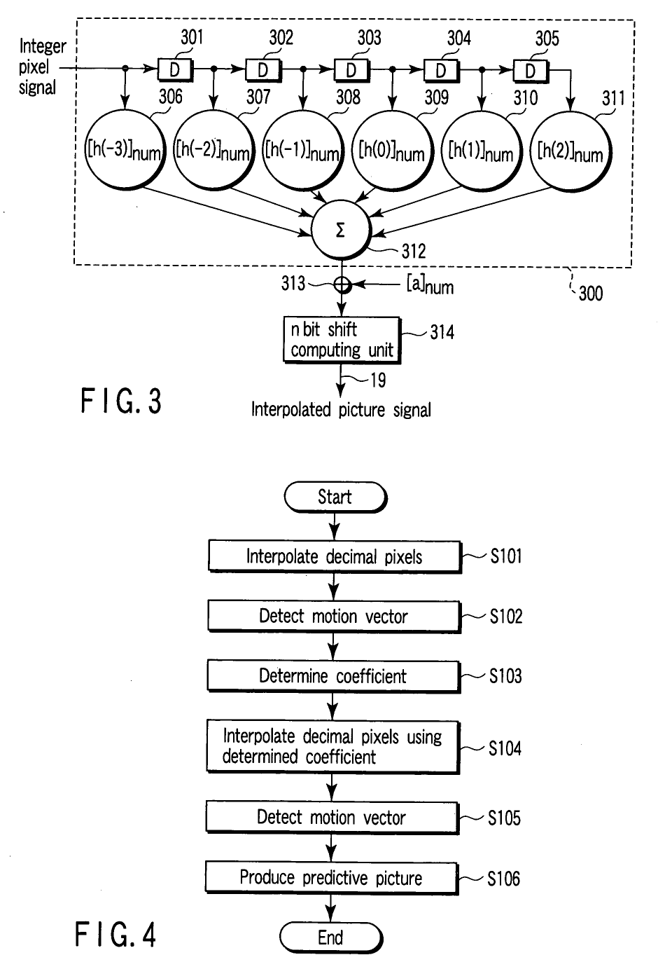

The pixel interpolator 201 will be described referring to FIG. 3.

When the fractional pixel interpolation is performed in horizontal, at first the pixel value of the local decoded picture signal 14 which is a signal of an integer pixel is input to a filter 300 in a raster scan sequence. The filter comprises delay units 301-305, coefficient multipliers 306-311 and an adder 312. In the filter 300, the input pixel value of the local decoded picture signal 14 is stored in the delay unit 301, and the pixel value previously input to and stored in the delay unit 301 is output. Other delay units 302, 303 and 304 operate similarly to the delay unit 305.

The coefficient multiplier 306 multiplies the input pixel value of the local decoded picture signal 14 by a constant [h(−3)]num. num is 2n, and [r]num assumes a numerator of r when a common num is used for the denominator. Similarly, other coefficient multipliers 307, 308, 309, 310 and 311 multiplies respective input pixel values by the constant [h(−2)]num, [h(−1)]num, [h(0)]num, [h(1)]num, [h(2)], respectively. The adder 312 calculates a sum of values output from all coefficient multipliers 306-311 to produce an output signal of the filter 300.

An adder 313 adds the output signal from the filter 300 and a constant [a]num. For the constant [a]num is used a numerator of a coefficient indicating a pixel value change between the to-be-encoded picture and the encoded picture. The output signal from the adder 313 is shifted by n bits with an n-bit shift computing unit 314, that is, subjected to ½n=1/num times, whereby an interpolation picture signal 19 is finally derived. FIG. 3 shows an example computing a pixel value of an interpolation picture using six pixel values. However, the pixel value of interpolation picture may be computed using a plurality of pixel values. The operation of the pixel interpolator 201 will be described in detail later.

Routine of the motion compensation predictor 108 will be described referring to a flowchart shown in FIG. 4.

In step S101, the interpolation picture signal 19 of ½ pixel precision is generated from the local decoded picture signal 14 using the pixel interpolator 201. In this case, a filter suitable for an interpolation of ½ pixel precision is used. For example, a filter of filter coefficients ( 1/32, − 5/32, 20/32, 20/32, − 5/32, 1/32) used in ITU-T H.264/MPEG-4 Part 10 AVC is used.

In next step S102, a motion vector is derived based on the input video signal 11 and the interpolation picture signal 19 from the pixel interpolator 201 with the motion detector 204. Because the method of detecting a motion vector is well known, the detailed description is omitted here.

In next step S103, an interpolation coefficient to make a square error between the input video signal 11 and the predictive picture signal 15 minimize is determined based on the input video signal 11, the motion vector from the motion detector 204, the local decoded picture signal 14 from the frame memory 107 with the coefficient determination unit 206. The method of determining an interpolation coefficient will be described in detail later.

In next step S104, the interpolation picture signal 19 is generated with the pixel interpolator 201 using the interpolation coefficient determined by the coefficient determination unit 206. In next step S105, the motion detection is again done by the motion detector 204 using the interpolation picture signal 19 generated in step S104. Then, the detected motion vector is sent to the predictive picture generator 203 and the entropy encoder 109 through the switch 205. At last, in step S106, the predictive picture signal 15 is generated with the predictive picture generator 203, and motion compensated prediction is finished.

The method of determining an interpolation coefficient to make a square error between the input video signal 11 and the predictive picture signal 15 minimize in step S103 will be described in detail.

The pixel of the predictive picture signal 15 is classified into three kinds of pixels according to the motion vector as follows: a pixel whose position on the encoded picture indicated by the motion vector is a position of ½ pixels (x−½, y) with respect to the x direction (horizontal direction), a pixel whose position on the encoded picture indicated by the motion vector is a position of ½ pixels (x, y−½) with respect to the y direction (vertical direction), and a pixel whose position on the encoded picture indicated by the motion vector is a position of ½ pixels (x−½, y−½) with respect to both of the x and y directions. Of these pixels, the pixel whose position indicated by the motion vector is the position (x, y−½) and the pixel whose position is the position (x−½, y) are used for determination of the interpolation coefficient.

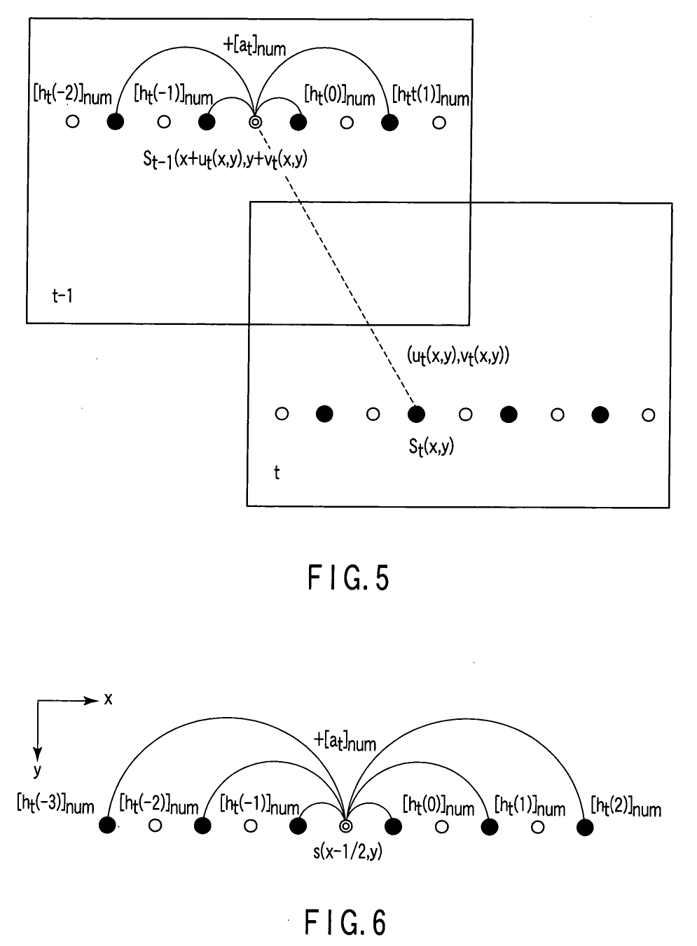

Using as an example a case that the pixel whose position on the encoded picture is the position (x−½, y) is used for determination of the interpolation coefficient, the operation of the coefficient determination unit 206 is explained referring to FIG. 5. FIG. 5 shows a mode of motion compensated prediction predicting a pixel on the to-be-encoded picture in a time point t from a pixel on the encoded picture in a time point t−1 before one time than the time t.

The pixel st(x, y) in the time point t is assumed to be predicted using the motion vector (ut(x, y), vt(x, y)) and the pixel st−1(x, y) at the time point t−1 according to the following equation (1):
sₜ^{(pred)}(x, y)=sₜ₋₁(x+uₜ(x, y), y+vₜ(x, y)) (1)
sₜ^{(pred)}(x, y) is a prediction pixel on the pixel sₜ(x, y).

When the pixel st−1(x+ut(x, y), y+vt(x, y)) at the position (x+ut(x, y), y+vt(x, y)) on the encoded picture in a time point t−1 that is indicated by the motion vector (ut(x, y),vt(x, y)) is a ½ pixel with respect to the x direction (horizontal direction), and an integer pixel with respect to the y direction (vertical direction) as shown in a double circle in FIG. 5, the pixel st−1(x+ut(x, y), y+vt(x, y)) is determined by an interpolation in the x direction. Then, the pixel st(x,y) is predicted using the coefficient at, ht(l) (1=−L, −L+1, . . . , L−1) as expressed by the following equation (2):

$${s}_{t}^{( pred )} ( x , y ) = {a}_{t} + {\sum }_{l = - L}^{L - 1} {h}_{t} ( l ) {s}_{t - 1} ( x + {\tilde{u}}_{t} ( x , y ) + l , y + {v}_{t} ( x , y ) ) \qquad ( 2 )$$

└r┘ is the smallest integer more than r, and assume that ũₜ(x, y) is the following equation (3):
   ũₜ(x, y)=└uₜ(x, y)┘ (3)

The right hand second term of the equation (2) is realized by operation of the filter 300 shown in FIG. 3. The addition of the coefficient at of right hand first term of the equation (2) is realized by addition of the constant [a]num with the adder 313 in FIG. 3 and the n-bit shift computing unit 314. In other words, the pixel value change between the to-be-encoded picture and the encoded picture is considered by the coefficient at in the equation (2).

When the error e(x, y) between corresponding pixels of the to-be-encoded picture and the predictive picture is defined by difference between the pixel st(x, y) and the prediction pixel as shown in an equation (4), the mean square error between the to-be-encoded picture and the predictive picture is expressed by an equation (5).
e(x,y)=sₜ(x,y)−sₜ^{(pred)}(x,y) (4)

$$MSE = {\sum }_{x ∈ \{ ( {u}_{t} ( x , y ) , {v}_{t} ( x , y ) ) = ( {k}_{1} - 1 / 2 , {k}_{2} ) \vert {k}_{1} , {k}_{2} ∈ Z \}} {e ( x , y )}^{2} \qquad ( 5 )$$

Z represents an integer. An equation (5) calculates a sum of the pixels that the position indicated by the motion vector is (x−½, y).

Subsequently, a coefficient to make the equation (5) minimize is derived. At first, a partial differential coefficient of a mean square error MSE between the to-be-encoded picture and the predictive picture in FIG. 5, which concerns coefficients at and hₜ(l) of the equation (2) is obtained by the following equations (6) and (7):

$$\begin{matrix}\frac{\partial MSE}{\partial {a}_{t}} = {\sum }_{x ∈ \{ ( {u}_{t} ( x , y ) , {v}_{t} ( x , y ) ) = ( {k}_{1} - 1 / 2 , {k}_{2} ) \vert {k}_{1} , {k}_{2} ∈ Z \}} 2 \frac{\partial e ( x , y )}{\partial {a}_{t}} e ( x , y ) & ( 6 ) \\ \frac{\partial MSE}{\partial {h}_{t} ( l )} = {\sum }_{x ∈ \{ ( {u}_{t} ( x , y ) , {v}_{t} ( x , y ) ) = ( {k}_{1} - 1 / 2 , {k}_{2} ) \vert {k}_{1} , {k}_{2} ∈ Z \}} 2 \frac{\partial e ( x , y )}{\partial {h}_{t} ( l )} e ( x , y ) & ( 7 ) \\ ( l = - L , - L + 1 ⋯ , L - 1 ) & \end{matrix}$$

If the equation is solved with the partial differential coefficient of the equations (6) and (7) assuming 0, coefficients aₜ and hₜ(l) can be obtained. The coefficients aₜ, hₜ(l) obtained in this way are substituted for the equation (2) to predict a pixel st(x,y). Similarly, coefficients bₜ, gₜ(m) (m=−M, −M+1, . . . , M−1) can be derived on the pixel that the position indicated by the motion vector is (x, y−½).

A numerator of a coefficient when the coefficients aₜ, hₜ(l), bₜ, gₜ(m) are converted into numerators [at]num, [ht(l)]num, [bt]num, [gt(m)]num of the coefficients when a common denominator 2n=m is used. However, the numerator of coefficient is rounded in integer. For example, [at]num is represented by the following equation:
[aₜ]ₙᵤₘ=└aₜ×num+½┘ (8)
└r┘ represents the maximum integer of not less than r.

The numerators [at]num, [ht(l)]num, [bt]num, [gt(m)]num of the coefficient and the exponent part n of the numerator are sent to the entropy encoder 204 from the coefficient determination unit 206 as coefficient information 17, and are entropy-encoded and send to the pixel interpolator 201.

The method of generating an interpolation picture signal 19 in the pixel interpolator 201 in step S104 will be described referring to FIG. 6.

The ½ pixel s(x−½, y) between the positions (x, y) and (1, x−y) is obtained based on the numerators [at]num, [ht(l)]num of the coefficient given from the coefficient determination unit 206 and the exponent part n of the numerator according to the following equation (9):

$$\begin{matrix}s ( x - 1 / 2 , y ) = ⌊ ( {[ {a}_{t} ]}_{num} + {\sum }_{l = - L}^{L - 1} {[ {h}_{t} ( l ) ]}_{num} s ( x + 1 , y ) + \\ {2}^{n - 1} ) ⪢ n ⌋\end{matrix} \qquad ( 9 )$$

>> represents right shift operation.

The ½ pixel s(x, y−½) between the positions (x, y) and (x, y−1) is derived using the numerators [bₜ]num, [gₜ(m)]] of a coefficient given from the coefficient determination unit 206 and the exponent part n of the numerator by the following equation (10):

$$\begin{matrix}s ( x , y - 1 / 2 ) = ⌊ ( {[ {b}_{t} ]}_{num} + {\sum }_{m = - M}^{M - 1} {[ {g}_{t} ( m ) ]}_{num} s ( x , y + m ) + \\ {2}^{n - 1} ) ⪢ n ⌋\end{matrix} \qquad ( 10 )$$

When the equations (9) or (10) are larger than the maximum value or smaller than the minimum value of a dynamic range of the pixel, a clipping process for correcting to the maximum value or minimum value of the dynamic range is done. All pixel values derived by computation are assumed to be subjected to the clipping process.

When the pixel s(x−½, y−½) of the pixel position (x−½, y−½) is interpolated in a vertical direction by the equation, using the pixel interpolated in a horizontal direction by a procedure similar to a conventional technique, the pixel value is derived by the following equation.

$$\begin{matrix}s ( x - 1 / 2 , y - 1 / 2 ) = ⌊ ( {[ {b}_{t} ]}_{num} + \\ {\sum }_{m = - M}^{M - 1} {[ {g}_{t} ( m ) ]}_{num} s ( x - 1 / 2 , y + m ) + \\ {2}^{n - 1} ) ⪢ n ⌋\end{matrix} \qquad ( 11 )$$

A numerator [aₜ]num of a coefficient representing a pixel value change between the to-be-encoded picture and the encoded picture in the equation (9) is contained in s(x−½, y+m) contained in the equation (11). A numerator [bₜ]num of a coefficient representing a pixel value change is contained in the equation (11) too, resulting in considering a pixel value change double.

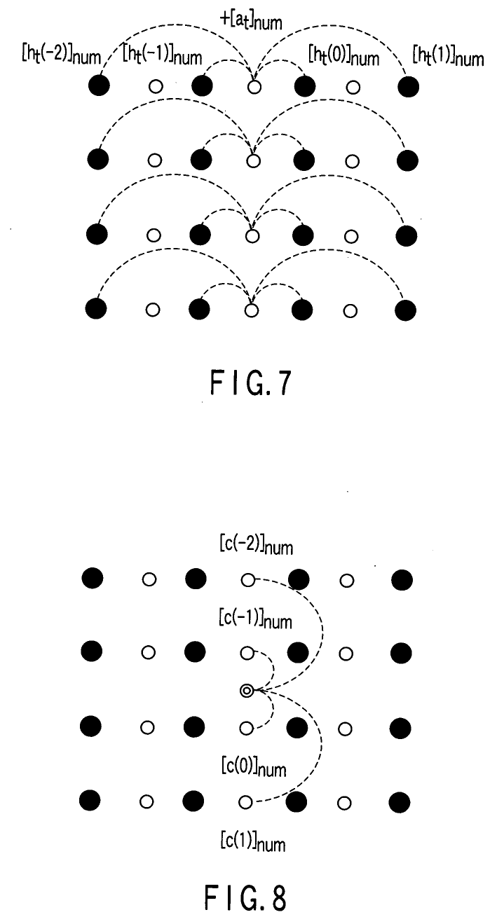

Consequently, in the present embodiment, the pixel of the position (x−½, y) interpolated in a horizontal direction using an equation (9) as shown in FIGS. 7 and 8 is interpolated in a vertical direction to obtain a pixel s(x−½, y−½). The filter uses a filter suitable for an interpolation of ½ pixel resolution. For example, a filter of filter coefficients ( 1/32, − 5/32, 20/32, 20/32, − 5/32, 1/32) used in H.264/AVC as used in step S101 is used. A pixel whose pixel position is s(x−½, y−½) is obtained by the following equation (12):

$$\begin{matrix}s ( x - 1 / 2 , y - 1 / 2 ) = ⌊ ( {\sum }_{m = - M}^{M - 1} {[ c ( m ) ]}_{num} s ( x - 1 / 2 , y + m ) + \\ {2}^{n - 1} ) ⪢ n ⌋\end{matrix} \qquad ( 12 )$$

It is assumed that [c(m)]num is expressed by the following equation (13) similarly to the numerator [at]num of a coefficient.
[c(m)]ₙᵤₘ=└c(m)×num+½┘ (13)

The method of interpolating the pixel interpolated in a horizontal direction based on the equation (9) in a vertical direction using a filter is described above. However, the pixel interpolated in the horizontal direction using the filter may interpolated in the vertical direction by the equation (10). The generated interpolation picture signal is sent to the predictive picture generator 203 and the motion detector 204 through the switch 202.

The position of the pixel used for interpolation in steps S101 and S104 and for determining the interpolation in step S103 may be out of the screen. With the pixel out of the screen, it is assumed that the pixel located at the edge of the screen is extended or the pixel is extended so that the picture signal becomes symmetric with respect to the edge of the screen.

There will be explained entropy encoding of an interpolation coefficient hereinafter. The entropy encoder 109 receives as coefficient information 17 the numerators of the coefficient: [at]num, [ht(l)]num, [bt]num, [gt(m)]num and an exponential part of the denominator of the coefficient, and encodes them in units of syntax such as frame, field, slice or GOP.

The present embodiment describes a method of making a square error minimize. However, the interpolation coefficient may be derived based on a reference of other errors. A method of doing motion compensated prediction from a picture of a time point t−1 is described. However, the motion compensated prediction may be performed using the encoded picture before the time point t−1.

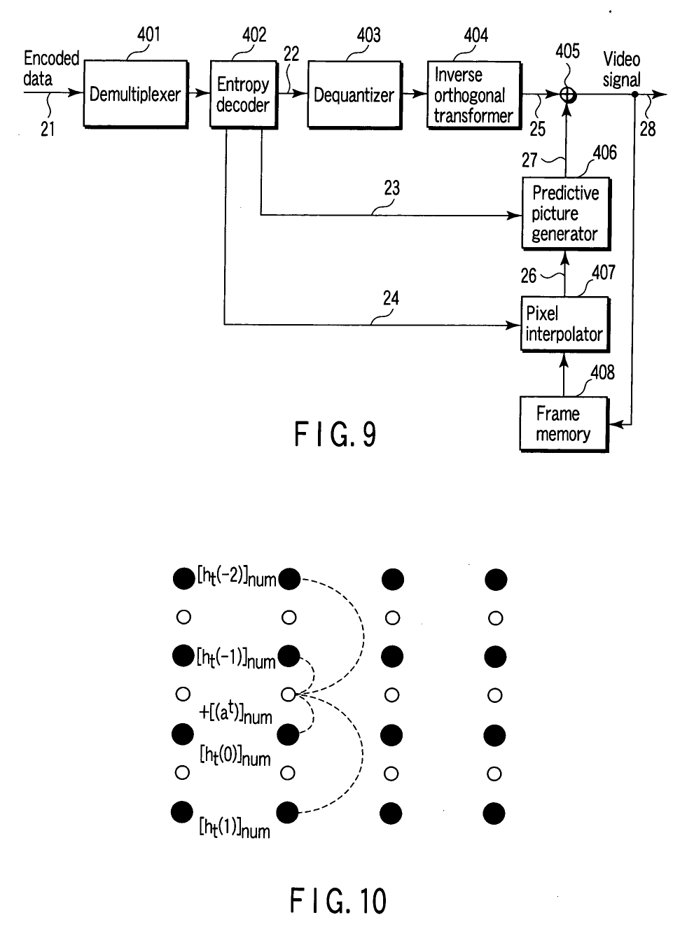

A video decoding apparatus concerning the first embodiment will be described referring to FIG. 9. The encoded data 18 output by the video encoding apparatus of FIG. 1 is input to the video decoding apparatus as encoded data 21 to be decoded through a storage system or a transmission system. The encoded data 21 includes codes of quantized orthogonal transformed coefficient information, motion vector information and interpolation coefficient information. These codes are demultiplexed by a demultiplexer 401, and decoded with an entropy decoder 402. As a result, the entropy decoder 402 outputs quantized orthogonal transformation coefficient information 22, motion vector information 23 and interpolation coefficient information 24. The interpolation coefficient information 24 is information of an interpolation coefficient representing a pixel value change between the to-be-encoded picture and the encoded picture in the video encoding apparatus shown in FIG. 1. However, viewing in the video decoding apparatus side, it is information of interpolation coefficient representing a pixel value change between the to-be-decoded picture and the decoded picture.

Of the information output from entropy decoder 402, quantized orthogonal transformation coefficient information 22 is sent to a dequantizer 403, motion vector information 23 is sent to a predictive picture generator 406, and the numerator [at]num, [ht(l)]num, [bt]num, [gt(m)]num of the coefficient of interpolation coefficient information 24 and an exponent part n of the denominator of the coefficient is sent to an pixel interpolator 407.

The quantized orthogonal transformation coefficient information 22 is dequantized with the dequantizer 403, and then subjected to inverse orthogonal transformation by an orthogonal transformer 404 thereby to produce a prediction error signal 25. An adder 405 adds the prediction error signal 25 and the predictive picture signal 27 to reproduce a video signal 28. The reproduced video signal 28 is stored in a frame memory 408.

The pixel interpolator 407 generates an interpolation picture signal 26 using the video signal stored in the frame memory 408 and the numerator [at]num, [ht(l)]num, [bt]num, [gt(m)]num of the coefficient of the interpolation coefficient information and an exponent part n of the denominator of the coefficient which are given by the demultiplexer 401. The pixel interpolator 407 performs interpolation similar to that of the pixel interpolator 201 of FIG. 2 in the first embodiment. In the last, a predictive picture on the interpolation picture is generated with a predictive picture generator 406 using the motion vector information 23 and send to an adder 405 to produce a video signal 28.

### Second Embodiment

There will be explained the second embodiment of the present invention.

The basic configuration of the video encoding apparatus regarding the present embodiment is similar to that of the first embodiment. The present embodiment supposes that the properties of the horizontal and vertical picture signals are the same, the same coefficient is used for both of the horizontal and vertical directions as shown by the following equations (14) and (15).
aₜ=bₜ (14)
hₜ(l)=gₜ(l) (l=−L, −L+1, . . . , L−1) (15)

In determination of an interpolation coefficient, the equations (5), (6) and (7) of the first embodiment are modified to calculate a sum of the pixel located at the position (x−½, y) indicated by a motion vector and the pixel located at the position (x, y−½). The mean square error and partial differential coefficient are represented by the following equations (16), (17) and (18):

$$\begin{matrix}MSE = {\sum {e ( x , y )}^{2}}_{\begin{matrix}x ∈ \{ ( {u}_{t} ( x , y ) , {v}_{t} ( x , y ) ) = ( {k}_{1} - 1 / 2 , {k}_{2} ) \vert {k}_{1} , {k}_{2} ∈ Z \} ⋃ \\ \{ ( {u}_{t} ( x , y ) , {v}_{t} ( x , y ) ) = ( {k}_{1} , k - 1 / 2 \vert ) {k}_{1} , {k}_{2} ∈ Z \}\end{matrix}} & ( 16 ) \\ \frac{\partial MSE}{\partial {a}_{t}} = {\sum }_{\begin{matrix}x ∈ \{ ( {u}_{t} ( x , y ) , {v}_{t} ( x , y ) ) = ( {k}_{1} - 1 / 2 , {k}_{2} ) \vert {k}_{1} , {k}_{2} ∈ Z \} ⋃ \\ \{ ( {u}_{t} ( x , y ) , {v}_{t} ( x , y ) ) = ( {k}_{1} , {k}_{2} - 1 / 2 ) \vert {k}_{1} , {k}_{2} ∈ Z \}\end{matrix}} 2 \frac{\partial e ( x , y )}{\partial {a}_{t}} e ( x , y ) & ( 17 ) \\ \frac{\partial MSE}{\partial h ( i )} = {\sum }_{\begin{matrix}x ∈ \{ ( {u}_{t} ( x , y ) , {v}_{t} ( x , y ) ) = ( {k}_{1} - 1 / 2 , {k}_{2} ) \vert {k}_{1} , {k}_{2} ∈ Z \} ⋃ \\ \{ ( {u}_{t} ( x , y ) , {v}_{t} ( x , y ) ) = ( {k}_{1} , {k}_{2} - 1 / 2 ) \vert {k}_{1} , {k}_{2} ∈ Z \}\end{matrix}} 2 \frac{\partial e ( x , y )}{\partial h ( i )} e ( x , y ) & ( 18 ) \\ ( i = - L , - L + 1 ⋯ , L - 1 ) & \end{matrix}$$

If the equations (17) and (18) are solved with the partial differential coefficient set to 0, the coefficients aₜ, hₜ(l) that are common to horizontal and vertical interpolations can be derived. The interpolation is performed similarly to step S104 of the first embodiment using the numerator [at]num, [ht(l)]num] of the decided coefficient in common in the horizontal and vertical directions as shown in FIGS. 7 and 10.

According to the second embodiment, the interpolation coefficients used for horizontal and vertical interpolations can be decreased in number in comparison with the case of providing the interpolation coefficients for the horizontal and vertical directions separately. Accordingly, the number of encoded bits necessary for sending the coefficient information 17 can be decreased compared with the first embodiment because the number of numerators of the coefficient to be subjected to entropy encoding decreases.

According to the present invention, by fractional pixel interpolation in consideration of a pixel value change between a to-be-encoded picture and encoded picture, a prediction error for a picture that the pixel value varies in terms of time, for example, a fade-in fade-out picture can be decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method of encoding a video using motion compensated prediction comprising:
determining an interpolation coefficient for making a prediction error between a to-be-encoded picture and a predictive picture minimize, the interpolation coefficient representing a pixel value change between the to-be-encoded picture and the encoded picture;
interpolating a pixel in a position between adjacent pixels of the encoded picture using the interpolation coefficient to generate an interpolation picture;
generating the predictive picture by subjecting the interpolation picture to motion compensated prediction; and
encoding the prediction error between the to-be-encoded picture and the predictive picture.

2. The method according to claim 1, wherein generating the predictive picture includes detecting a motion vector from the interpolation picture and the to-be-encoded picture and generating the predictive picture by the motion compensated prediction using the interpolation picture and the motion vector.

3. The method according to claim 2, wherein the encoding comprises subjecting the prediction error to orthogonal transformation to generate an orthogonal transformation coefficient, quantizing the orthogonal transformation coefficient, and entropy-encoding the quantized orthogonal transformation coefficient, the motion vector used for the motion compensated prediction and the interpolation coefficient to produce encoded data.

4. The method according to claim 2, wherein detecting the motion vector includes providing the motion vector for interpolating the pixel and generating the predictive picture or providing the motion vector for determining the interpolation coefficient.

5. The method according to claim 2, which includes generating a local decoded picture, and wherein determining the interpolation coefficient includes determining the interpolation coefficient using the to-be-encoded picture, the local decoded picture and the motion vector.

6. The method according to claim 2, wherein interpolating the pixel includes providing the interpolation picture for generating the predictive picture and detecting the motion vector or providing the interpolation picture only for detecting the motion vector.

7. The method according to claim 1, wherein generating the interpolation picture includes deriving the interpolation coefficient by setting to 0 a partial differential coefficient on an interpolation coefficient for a mean square error between the to-be-encoded picture and the predictive picture.

8. The method according to claim 1, wherein generating the interpolation picture includes, when interpolating a pixel in a position between the adjacent pixels with respect to both of a horizontal direction and a vertical direction, interpolating the pixel using an interpolation filter and the interpolation coefficient for one of the horizontal direction and the vertical direction, and interpolating the pixel using only the interpolation filter for the other of the horizontal direction and the vertical direction.

9. The method according to claim 1, wherein determining the interpolation coefficient includes determining as the interpolation coefficient a coefficient common to both of the horizontal direction and the vertical direction.

10. The method according to claim 1, wherein determining the interpolation coefficient includes determining the interpolation coefficient for making a square error between the to-be-encoded picture and the predictive picture minimize.

11. A video encoding apparatus using motion compensated prediction comprising:
a determination unit configured to determine an interpolation coefficient for making an error between a to-be-encoded picture and a predictive picture minimize, the interpolation coefficient representing a pixel value change between the to-be-encoded picture and the encoded picture;
an interpolator to subject the encoded picture to a fractional pixel interpolation using the interpolation coefficient to generate an interpolation picture;
a predictive picture generator to generate the predictive picture by performing motion compensated prediction using the interpolation picture; and
an encoder to encode the prediction error between the to-be-encoded picture and the predictive picture.

12. The apparatus according to claim 11, wherein the predictive picture generator includes a motion vector detector to detect a motion vector from the interpolation picture and the to-be-encoded picture and a predictive picture generator to generate the predictive picture by the motion compensated prediction using the interpolation picture and the motion vector.

13. The apparatus according to claim 12, wherein the encoder comprises an orthogonal transformer to subject the prediction error to orthogonal transformation to generate an orthogonal transformation coefficient, a quantizer to quantize the orthogonal transformation coefficient, and an entropy encoder to entropy-encode the quantized orthogonal transformation coefficient, the motion vector used for the motion compensated prediction and the interpolation coefficient to produce encoded data.

14. The apparatus according to claim 12, wherein the motion detector includes a switch to provide the motion vector to the interpolator and the predictive picture generator or provide the motion vector to the determination unit.

15. The apparatus according to claim 12, which includes a local decoder to generate a local decoded picture, and wherein the determination unit includes a unit configured to determine the interpolation coefficient using the to-be-encoded picture, the local decoded picture and the motion vector.

16. The method according to claim 12, wherein the interpolator includes a switch to provide the interpolation picture to the predictive picture generator and the motion detector or provide the interpolation picture only for detecting the motion vector.

17. A video decoding method comprising:
decoding an input encoded data to derive a quantized orthogonal transformation coefficient, a motion vector and an interpolation coefficient representing a pixel value change between a to-be-decoded picture and a decoded pictures,
interpolating a pixel in a position between adjacent pixels of the decoded picture using the interpolation coefficient to produce an interpolation picture;
generating a predictive picture by subjecting the interpolation picture to motion compensated prediction using the motion vector to produce a predictive picture;
obtaining a prediction error using the orthogonal transformation coefficient; and
reproducing the to-be-decoded picture from the predictive picture and the prediction error.

18. The method according to claim 17, wherein generating the interpolation picture includes, when interpolating a pixel in a position between the adjacent pixels with respect to both of a horizontal direction and a vertical direction, performing interpolation using an interpolation filter and the interpolation coefficient with respect to one of the horizontal direction and the vertical direction, and performing interpolation using only the interpolation filter with respect to the other of the horizontal direction and the vertical direction.

19. The method according to claim 17, wherein determining the interpolation coefficient includes determining as the interpolation coefficient a coefficient common to both of the horizontal direction and the vertical direction.

20. A video decoding apparatus comprising:
a decoder to decode an input encoded data to derive a quantized orthogonal transformation coefficient, a motion vector and an interpolation coefficient representing a pixel value change between a to-be-decoded picture and a decoded pictures;
an interpolator to interpolate a pixel in a position between adjacent pixels of the decoded picture using the interpolation coefficient to produce an interpolation picture;
a predictive picture generator to generate a predictive picture by subjecting the interpolation picture to motion compensated prediction using the motion vector;
a prediction error calculator to calculate a prediction error using the orthogonal transformation coefficient; and
a reproducer to reproduce the to-be-decoded picture from the predictive picture and the prediction error.
